(19) United States
(12) Patent Application Publication
(10) Pub. No.: US 2008/0046496 A1
(43) Pub. Date: Feb. 21, 2008

(54) Multi-functional keyboard on touch screen

(75) Inventor: Arthur Kater, Taipei (TW)

Correspondence Address: TROXELL LAW OFFICE PLLC, 5205 LEESBURG PIKE, SUITE 1404, FALLS CHURCH, VA, 22041, US

(73) Assignee: Arthur Kater, Taipei (TW)

(21) Appl. No.: 11/607,046

(22) Filed: Dec. 1, 2006

(30) Foreign Application Priority Data
May 18, 2006 (TW) 095208549

(51) Int. Cl. G06F 7/38

(52) U.S. Cl. 708/524

(57) ABSTRACT

A touch screen has a keyboard which has several areas of keys. Each area is sizable, including enlarging and shrinking, and movable. Because the sizes of the keys areas are controllable, the keyboard does not occupy the whole screen and the areas are not too small to clearly see the keys. With the present invention, more room is left for flexible operations.

### FIELD OF THE INVENTION

The present invention relates to a keyboard on a touch screen; more particularly, relates to changing a display status of a key area to fulfill user's requests.

### DESCRIPTION OF THE RELATED ART

A general keyboard structure 5 for touch screen comprises a touch screen 51 and a keyboard 52 in the touch screen 51. The keyboard 52 comprises a main key area 521, a number key area 522 and a function key area 523, where a user hits a key in the main key area 521, the number key area 522 or the function key area 523 on the touch screen 51; after a recognition and an operation through an operation member, a key definition member feeds back a key definition to the operational member to be confirmed and then the key definition is outputted to be displayed on the touch screen 51.

Although the keyboard structure 5 displays the key on the touch screen 51, the main key area 521, the number key area 522 and the function key area 523 are horizontally fixed at the lower part on the touch screen 51, whose sizes, shapes and arrangement are not changeable. Therefore, when a user wants to use the main key area 521, the number key area 522 or the function key area 523 only, the main key area 521, the number key area 522 and the function key area 523 are still displayed simultaneously. A great part of the touch screen 51 is still occupied and no additional room is left for flexibility. Hence, the prior art does not fulfill users' requests on actual use.

### SUMMARY OF THE INVENTION

The main purpose of the present invention is to input a key display status or a key usage status from an I/O control unit; after being computed in an algorithm unit coordinated with a memory unit and a key definition unit, to display the key display status or the key usage status by the I/O control unit; and then so to change the display statuses of key areas to fulfill user's requests.

To achieve the above purpose, the present invention is a multi-functional keyboard on a touch screen, comprising an I/O control unit, an algorithm unit, a memory unit and a key definition unit, where the I/O control unit has a plurality of key areas to input a key display status or a key usage status; the algorithm unit is connected with the I/O control unit to receive the key display status or the key usage status; the memory unit has a display status database and is connected with the algorithm unit to receive signal of the key display status to be displayed by the I/O control unit; and the key definition unit is connected with the algorithm unit and receives signal of the key usage status to be displayed by the I/O control unit. Accordingly, a novel multi-functional keyboard on a touch screen is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the perspective view showing the preferred embodiment according to the present invention;

FIG. 2 is the block view;

FIG. 3 is the first view showing changing the key display status;

FIG. 4 is the block view showing the flow for the key display status;

FIG. 5 is the view showing the key usage status;

FIG. 6 is the block view showing the flow for the key usage status;

FIG.7 is the second view showing changing the key display status;

FIG. 8 is the third view showing changing the key display status; and

FIG. 9 is the perspective view of the prior art.

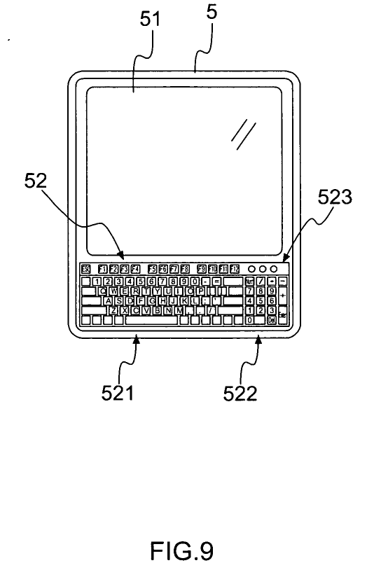

### DESCRIPTION OF THE PREFERRED EMBODIMENT

The following description of the preferred embodiment is provided to understand the features and the structures of the present invention.

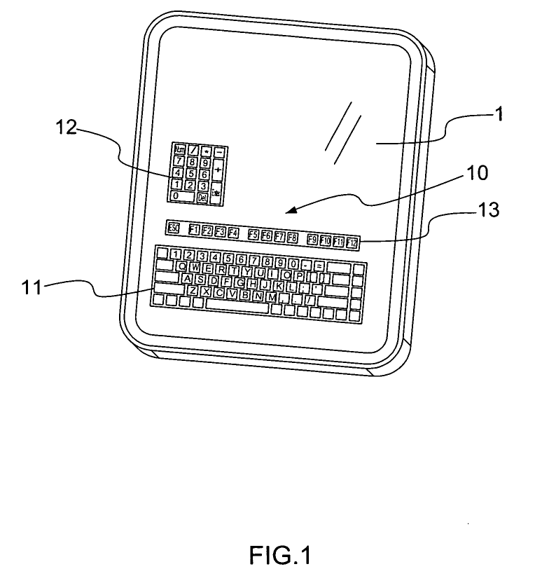

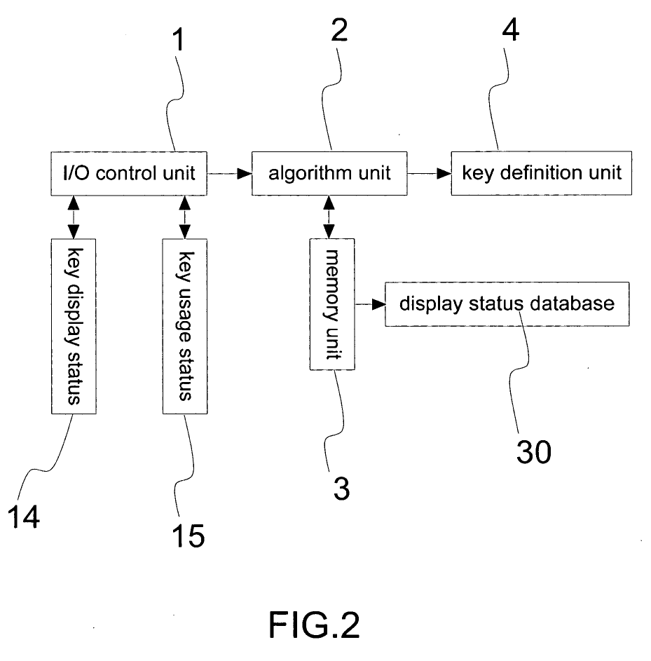

Please refer to FIG. 1 and FIG. 2 which are a perspective view and a block view showing a preferred embodiment according to the present invention. As shown in the figures, the present invention is a multi-functional keyboard on a touch screen, comprising an input/output (I/O) control unit 1, an algorithm unit 2, a memory unit 3 and a key definition unit 4, where statuses of key areas are changed to fulfill user's requests.

The I/O control unit 1 is a touch screen and comprises a key area zone 10, where the key area zone 10 comprises a main key area 11, a number key area 12 and a function key area 13; and inputs a key display status 14 or a key usage status 15.

The algorithm unit 2 is connected with the I/O control unit 1 and receives the key display status 14 or the key usage status to be recognized and computed.

The memory unit 3 is connected with the algorithm unit 2 and comprises a display status database 30, where the memory unit 3 receives the key display status 14 after the key display status 14 is computed by the algorithm unit 2; the key display status 14 is fed back to the algorithm unit 2 to be confirmed; and then the key display status 14 is outputted by the I/O control unit 1.

The key definition unit 4 is connected with the algorithm unit 2, where the key definition unit 4 receives the key usage status 15 after the key usage status 15 is computed by the algorithm unit 2; the key usage status 15 is fed back to the algorithm unit 2 to be confirmed; and then the key usage status 15 is outputted by the I/O control unit 1. Thus a novel multi-functional keyboard on a touch screen is obtained.

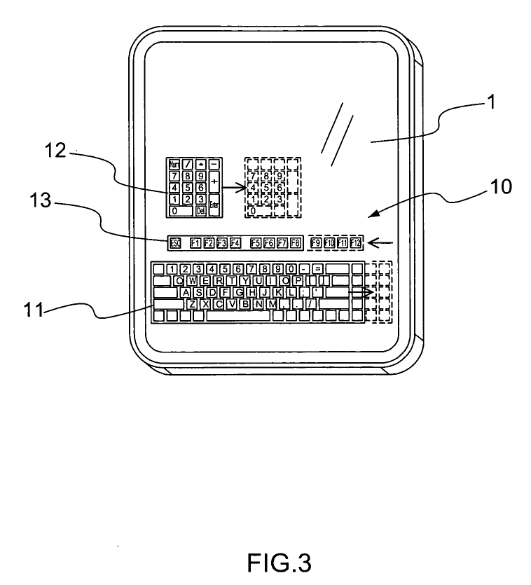

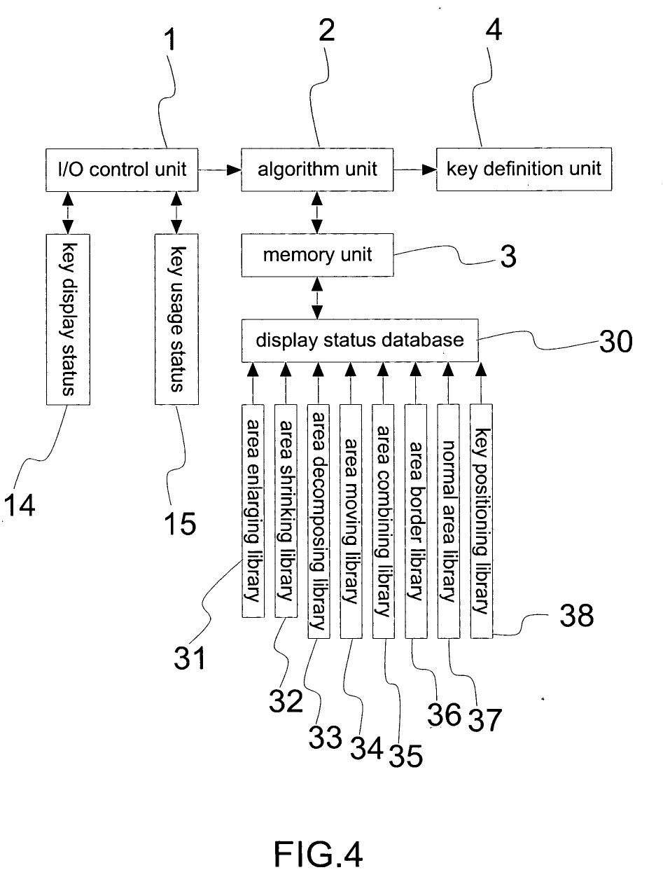

Please refer to FIG. 3 and FIG. 4, which are a first view showing changing a key display status and a block view showing a flow for the key display status. As shown in the figures, when operating a key display status 14 in a key area zone 10 of an I/O control unit 1, a user directly in puts the key display status 14 from the key area zone 10, where the key display status 14 is an operation signal for enlarging, shrinking, decomposing, moving, combining, border changing, normalizing, and position changing; and the key area zone 10 comprises a main key area 11, a number key area 12 and a function key area 13. The operation signal of the key display status 14 is then transferred to and received by an algorithm unit 2 by the I/O control unit 1 to be recognized and computed. And then the computed key display status 14 is transferred to a memory unit 3 by the algorithm unit 2. Corresponding data to the operation of the key display status 14 is obtained from operation libraries in a display status database 30 of the memory unit 3, where the operation libraries comprises an area enlarging library 31, an area shrinking library 32, an area decomposing library 33, an area moving library 34, an area combining library 35, an area border library 36, a normal area library 37 and a key positioning library 38. After the data to the operation of the key display status 14 are fed back to the algorithm unit 2, the operation for the key display status 14 is outputted by the I/O control unit 1 to show the status of the main key area 11, the number key area 12 or the function key area 13 as the user operates.

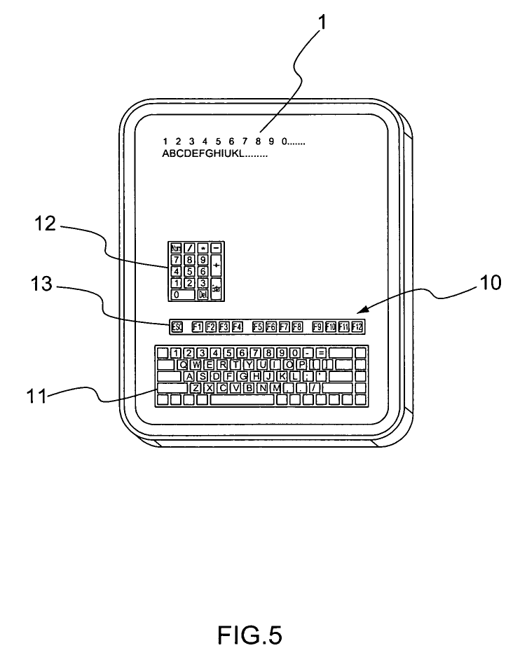

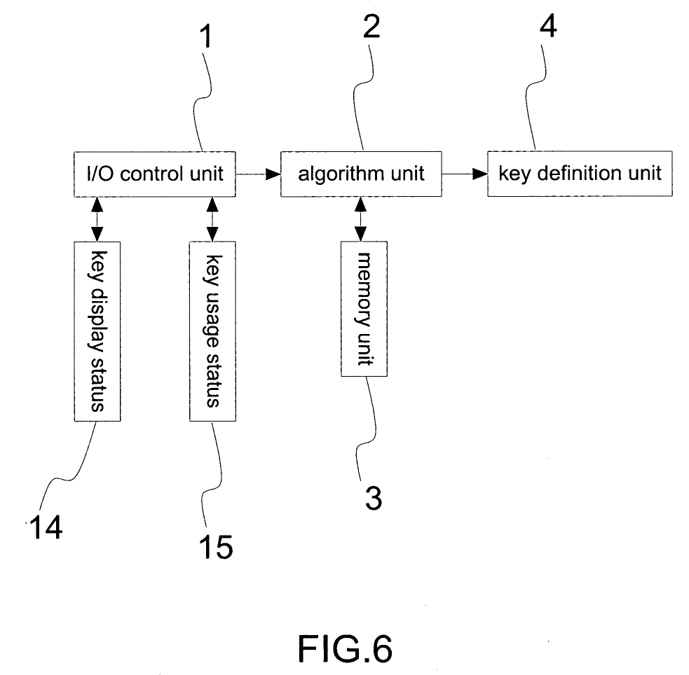

Please refer to FIG. 5 and FIG. 6, which are a view showing a key usage status and a block view showing a flow for the key usage status. As shown in the figures, when operating a key usage status 15 in a key area zone 10 of an I/O control unit 1, a user inputs the key usage status 15 from the key area zone 10, where the key area zone 10 comprises a main key area 11, a number key area 12 and a function key area 13. The operation signal of the key usage status 15 is then transferred to and received by an algorithm unit 2 by the I/O control unit 1 to be recognized and computed. And then the computed key usage status 15 is transferred to a key definition unit 4 by the algorithm unit 2. After a key definition is fed back to the algorithm unit 2, the key definition for the key usage status 15 is outputted by the I/O control unit 1 to show the key hit amidst the main key area 11, the number key area 12 or the function key area 13 as the user operates.

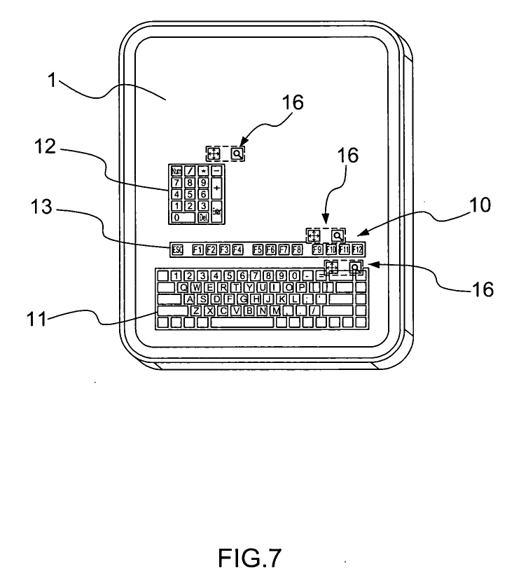

Please refer to FIG. 7, which is a second view showing changing a key display status. As shown in the figure, a main key area 11, a number key area 12 and a function key area 13 of a key area zone 10 each has a hidden key 16 at a default position. The hidden key 16 is generally hidden at a space of the main key area 11, the number key area 12 and the function key area 13. When using the hidden key 16, a user touches at the space of the main key area 11, the number key area 12 or the function key area 13; and the hidden key 16 displays an enlarging icon, a shrinking icon and a moving icon. The user chooses an icon among the enlarging icon, the shrinking icon and the moving icon according to a request; then the enlarging icon, the shrinking icon and the moving icon are removed. In the process, an operation of enlarging, shrinking or moving of the main key area 11, the number key area 12 or the function key area 13 is chosen by the user through the I/O control unit 1. A signal of enlarging, shrinking or moving is then transferred from the hidden key 16 to the algorithm unit 2 to be recognized and computed. And then the signal for the key display status 14 after being computed is transferred to a memory unit 3 by the algorithm unit 2. At last, data for displaying the main key area 11, the number key area 12 or the function key area 13 are obtained from the display status database 30 of the memory unit 3 to be displayed by the I/O control unit 1.

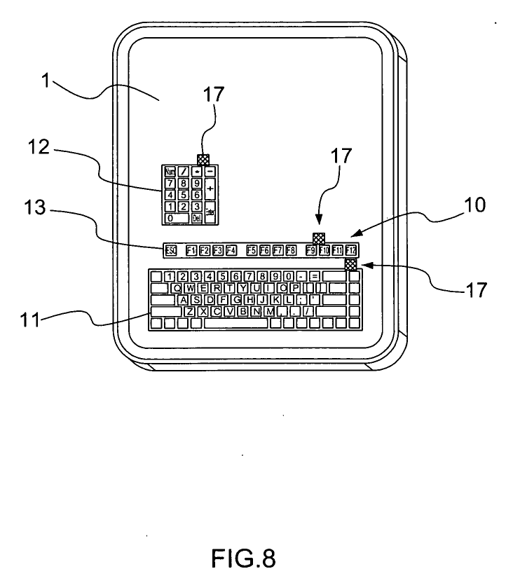

Please refer to FIG. 8 which is a third view showing changing a key display status. As shown in the figure, a main key area 11, a number key area 12 and a function key area 13 of a key area zone 10 each has a displayed key 17 at a default position. The displayed key 17 is generally displayed at an upper position of the main key area 11, the number key area 12 and the function key area 13. When using the displayed key 17, a user touches at the upper position of the main key area 11, the number key area 12 or the function key area 13; and the displayed key 17 displays an enlarging icon, a shrinking icon and a moving icon. The user chooses an icon among the enlarging icon, the shrinking icon and the moving icon according to a request; then the enlarging icon, the shrinking icon and the moving icon are removed. In the process, an operation of enlarging, shrinking or moving of the main key area 11, the number key area 12 or the function key area 13 is chosen by the user through the I/O control unit 1. A signal of enlarging, shrinking or moving is then transferred from the displayed key 17 to the algorithm unit 2 to be recognized and computed. And then the signal for the key display status 14 after being computed is transferred to a memory unit 3 by the algorithm unit 2. At last, data for displaying the main key area 11, the number key area 12 or the function key area 13 are obtained from the display status database 30 of the memory unit 3 to be displayed by the I/O control unit 1.

To sum up, the present invention is a multi-functional keyboard on a touch screen, where a key display status or a key usage status is inputted from an I/O control unit; after being computed in an algorithm unit coordinated with a memory unit and a key definition unit, the key display status or the key usage status is displayed by the I/O control unit; and the display statuses of key areas are changeable to fulfill user's requests.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A multi-functional keyboard on a touch screen, comprising:
an input/output (I/O) control unit, said I/O control unit comprising a key area zone;
an algorithm unit, said algorithm unit being connected with said I/O control unit;
a memory unit, said memory unit being connected with said algorithm unit, said memory unit having a display status data base and
a key definition unit, said key definition unit being connected with said algorithm unit,
wherein said I/O control unit inputs/outputs a status selected from a group consisting of a key display status and a key usage status;
wherein said algorithm unit receives a signal of said status to be recognized and computed, said status being selected from a group consisting of a key display status and a key usage status;
wherein said memory unit receives said key display status after said key display status is computed by said algorithm unit, then said key display status is fed back to said algorithm unit to be confirmed, and then said key display status is outputted by said I/O control unit;
wherein said key definition unit receives said key usage status after said key display status is computed by said algorithm unit, then a key definition is fed back to said algorithm unit to be confirmed, and then said key usage status is outputted by said I/O control unit.

2. The keyboard according to claim 1,
wherein said I/O control unit is a touch screen.

3. The keyboard according to claim 1,
wherein said key area zone comprises a main key area, a number key area and a function key area.

4. The keyboard according to claim 1,
wherein said display status database of said memory unit comprises an area enlarging library, an area shrinking library, an area decomposing library, an area moving library, an area combining library, an area border library, a normal area library and a key positioning library.

5. The keyboard according to claim 1,
wherein said key area has a hidden key at a default position; and
wherein said hidden key transfers an operation status signal to said algorithm unit to be recognized and computed, and data of a key display status corresponding to said operation status signal are obtained from said display status database of said memory unit.

6. The keyboard according to claim 1,
wherein said hidden key displays an enlarging icon, a shrinking icon and a moving icon.

7. The keyboard according to claim 1,
wherein said key area has a displayed key at a default position; and
wherein said hidden key transfers an operation status signal to said algorithm unit to be recognized and computed, and data of a key display status corresponding to said operation status signal are obtained from said display status database of said memory unit.

8. The keyboard according to claim 1,
wherein said displayed key displays an enlarging icon, a shrinking icon and a moving icon.
